(19) United States
(12) Patent Application Publication
(10) Pub. No.: US 2013/0174188 A1
(43) Pub. Date: Jul. 4, 2013

(54) METHOD AND SYSTEM TO IMPLICITLY LINK SECOND SCREEN ADVERTISEMENT CAMPAIGNS AND COMMERCE EVENTS TO MAIN SCREEN VIDEO AND AUDIO PROGRAM CONTENT

(71) Applicants: Luc Gagnon, St-Basile-le-Grand (CA); Rachad Alao, Montreal (CA); Marc Belanger, Laval (CA)

(72) Inventors: Luc Gagnon, St-Basile-le-Grand (CA); Rachad Alao, Montreal (CA); Marc Belanger, Laval (CA)

(73) Assignee: Bluestreak Technology, Inc., Montreal (CA)

(21) Appl. No.: 13/409,790

(22) Filed: Mar. 1, 2012

Related U.S. Application Data
(60) Provisional application No. 61/581,396, filed on Dec. 29, 2011.

(51) Int. Cl. H04N 21/24

(52) U.S. Cl. 725/13

(57) ABSTRACT

A system for executing, on a secondary screen device, interactive events linked to predetermined program content played on a main screen device. The secondary screen device has channel tuning capability for selecting channels to be played on the main screen device. The system includes an application service platform adapted to communicate with the secondary screen device for monitoring the channels selected to be displayed on the main screen device. The application service platform determines when the predetermined program content is played on the main screen device. The application service platform is adapted to send to the secondary screen device one or more of the interactive events linked to the predetermined program content.

### RELATED APPLICATIONS

This application is related to and claims priority to U.S. Provisional Patent Application Ser. No. 61/581,396, filed Dec. 29, 2011, which is incorporated herein in its entirety.

### FIELD OF THE INVENTION

This invention is directed generally to monitoring of consumer media habits, and, more particularly, to a system for communicating media channel information between a main screen device and a secondary screen device.

### BACKGROUND OF THE INVENTION

There exist systems that capture and analyze environmental sounds and images in order to take a sample of the activity in an environment (e.g. determining which song is playing at the radio by capturing samples via a microphone). These existing systems require the intervention of the user (media consumer) in order to explicitly take a sample of the environment.

There is a need to know what channels media consumers are watching in order to provide them with targeted interactive events such as advertising without requiring the user's intervention.

### SUMMARY OF THE INVENTION

According to one embodiment, a system executes, on a secondary screen device, interactive events linked to predetermined program content played on a main screen device. The secondary screen device has channel tuning capability for selecting channels to be played on the main screen device. The system includes an application service platform adapted to communicate with the secondary screen device for monitoring the channels selected to be displayed on the main screen device. The application service platform determines when the predetermined program content is played on the main screen device. The application service platform is adapted to send to the secondary screen device one or more of the interactive events linked to the predetermined program content.

According to another embodiment, a method is directed to executing on a secondary screen device interactive events linked to predetermined program content played on a main screen device. The secondary screen device has channel tuning capability for selecting channels to be played on the main screen device. The method includes monitoring the channels selected to be displayed on the main screen device, and determining when the predetermined program content is played on the main screen device. The method further includes sending to the secondary screen device one or more of the interactive events linked to the predetermined program content.

### BRIEF DESCRIPTION OF THE DRAWINGS

The invention may best be understood by reference to the following description taken in conjunction with the accompanying drawings.

FIG. 1 shows an embodiment of the system.

FIG. 2 shows an embodiment of the flow of the invention.

### DETAILED DESCRIPTION OF ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

This invention uses a second screen such as smart phones or tablets to tune the channel being watched or listened to either on a video screen or on an audio system. The channel information is then sent and processed by a backend system to develop a media consumer profile and historical data to enable interactivity and data mining.

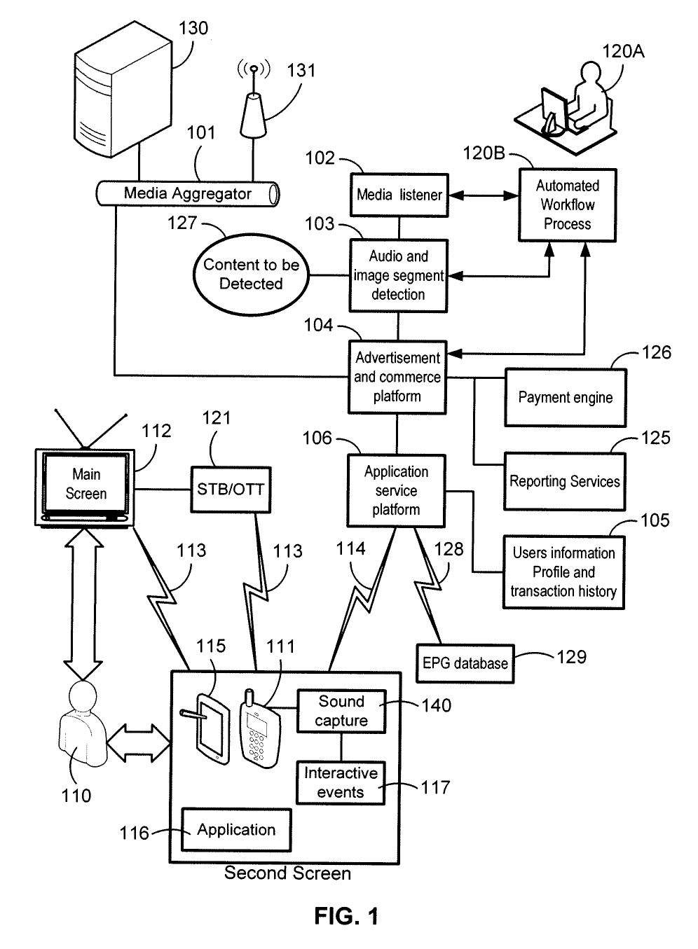

FIG. 1, shows an example of a system to link an application located on a second screen 111 to a main screen video or audio program content in real time without any check-in intervention from the user.

The link is done primarily by keeping track of users' main screen state transitions (channel changes, input changes, etc.) in the application service platform as further described below.

Media consumers (users) 110 of linear TV, broadcast TV, Video on Demand (VOD), Internet video content, and Cable TV (CATV) 112 often use a second screen 111 (Tablet PC, PC, Smartphone) to interact with applications (local or web based, social network, games, shopping, remote control, etc.) while watching their main video or audio program. An application 116 (native or web based) running on the second screens 111 has a tuning capability and communicates directly with a main screen 112 or a set-top box to control the channels of the main screen 112, via infrared, wireless or Bluetooth 113 signals. The second screen application 116 also communicates with application service platform 106 via the internet 114 to send the information of which channel is being tuned.

The application relies on a universal remote software module that includes all the IR codes or Bluetooth commands required to control the main screen device remotely. The universal remote software module relies on the internal device Bluetooth module or on an IR transceiver dongle connected through USB (Universal Serial Bus) or other common Mobile or tablet bus/port (PCMCIA, Serial, Audio jack, etc.).

When the application changes the state of the main screen using the universal remote software and reaches a stable state for a predefined time duration (e.g., 10 seconds) it sends a state transition notification to the application service platform using a predefined web based interface (REST api, SOAP interface, or any other web based RPC mechanism).

The Application Service platform maintains the history of main screen state transitions on a per user basis in its database. This enables the platform to know exactly which channel the main screen is currently tuned to.

Managed network (e.g., CATV, Satellite, IPTV), unmanaged network (e.g. Over the Top, Internet) video and radio media network channels 130, 131 are concentrated in a media aggregator 101. These media channels can come from any sources worldwide. Both audio and video sources can be exploited. Live or pre-recorded material can be used. The media listener 102 is used to continuously stream the audio and video content and to extract specific video, closed captioned text and audio.

An audio and image detection system 103 (e.g., Automatic Content Recognition) is used to identify in real time specific audio or image samples or predetermined program content (such as advertising) that is being played in real-time by the extracted audio/video content. Closed captioned text can also be detected in that module. The predetermined program content is kept into a database or repository 127. An advertisement and commerce platform 104 is used to manage what predetermined program content to extract and manage the interactive events that are triggered by the system in response to the detection of some predetermined program content.

The commerce platform has access to all the predetermined program content that have been detected by the matching system and also knows all the predetermined program content for which the system has additional promotional material (coupons, interactive games, etc.) to offer users. This knowledge is used to trigger interactive events whenever some predetermined program content is detected on one the channels or programs currently being watched by a given user.

Interactive events such as a targeted advertisement, a web application enabling a targeted commerce transaction, an electronic coupon, or even a new application are triggered by the combination of the campaign rules in the platform 104, the knowledge of the channel being watched, detection of specific events in audio, text, and video streams in the block 103 on the same live channel being watched by the user, and the information provided by the user's information and Profile and transaction history module 105. One example of an interactive event is a poll that is sent to the user via the second screen, while he is watching or listening to a specific program to obtain the user's opinion on the program or the content of the program. Another example of an interactive event is a voting ballot sent to the user in relation to the program that is currently being tuned. The result of the vote could optionally be sent back to influence the program content.

The system manager 120.A can configure through a web interface a workflow system 120.B that controls automatically the advertisement and commerce platform 104, selects channels (can be the full range) to be monitored in the media listener 102, provides rules and policies for the events, and adds labels to image and audio segments to be recognized in the audio and image segment detection component 103. If a detected segment (such as an ad) is not in the database of selected advertising, then it is extracted and provided to the system manager who can then decide whether to add it to the database or repository 127 and label it. It is therefore possible to have content samples to match all the ads being broadcasted in the media feed in a given period.

The reporting service block 125 includes analytical data, data mining tools, and predictive analysis functionality for the campaign manager to perform what-if-scenarios. It is possible to monitor how often media consumers are watching certain ads and programs on their main screens and simulate the effect of certain targeted campaigns exploiting the invention. It is also possible to precisely measure at what time within a program the media consumer changed channels. Comprehensive down to the second usage and viewing statistics can therefore be computed and used for channel usage polls.

Optionally, a payment engine 126 is used to tally and compile royalty reports, to enable transaction with consumers, and to interface to third party payment platforms.

Note that the media consumer can watch TV in a different location with different main screen devices (friends' TV or PCs, etc.) and the EPG information can be updated by 105 into the second screen 111. The application service platform can determine the appropriate EPG by questioning the media consumer 110 or by automatically getting geo-location data from the second screen devices 111 (GPS, internet IP addresses).

The appropriate EPG is selected based on the user's location (country+zipcode), Pay TV and OTT video service providers. A lookup is performed in the Application Service Platform EPG database using these pieces of information to return the correct channel and program lineup as well as the corresponding EPG data for this particular user.

Optionally, the media consumer can logon to the second screen applications by using face or audio speaker recognition, fingerprinting, or just a standard logging screen. This way increased personalization of the interactive events 117 is possible because the media consumer 110 and his/hers preferences are also known as opposed to only knowing of the physical devices.

The user profile and transaction history kept in 105 can be dynamically updated every time a channel interaction is executed by the user and used in conjunction with the knowledge of the main screens being tuned 114, the detection of the live content being played 103, and the advertisement campaign rules to provide further targeted events to the media consumer 110.

Another key objective of the invention is that it is possible to associate advertisement and commercial events on the second screens with live advertisement being played on the main screens (not only the program itself). Multiple-screens same vendor campaigns can thus be synchronized in real time. In one embodiment of the invention, a restaurant could advertise a special deal on the main screens 112 and the application service platform 106 would send an event 117 such as a web application, a widget, an electronic coupon, or a ready for immediate transaction application dialogue related to the product being advertised on the main screens.

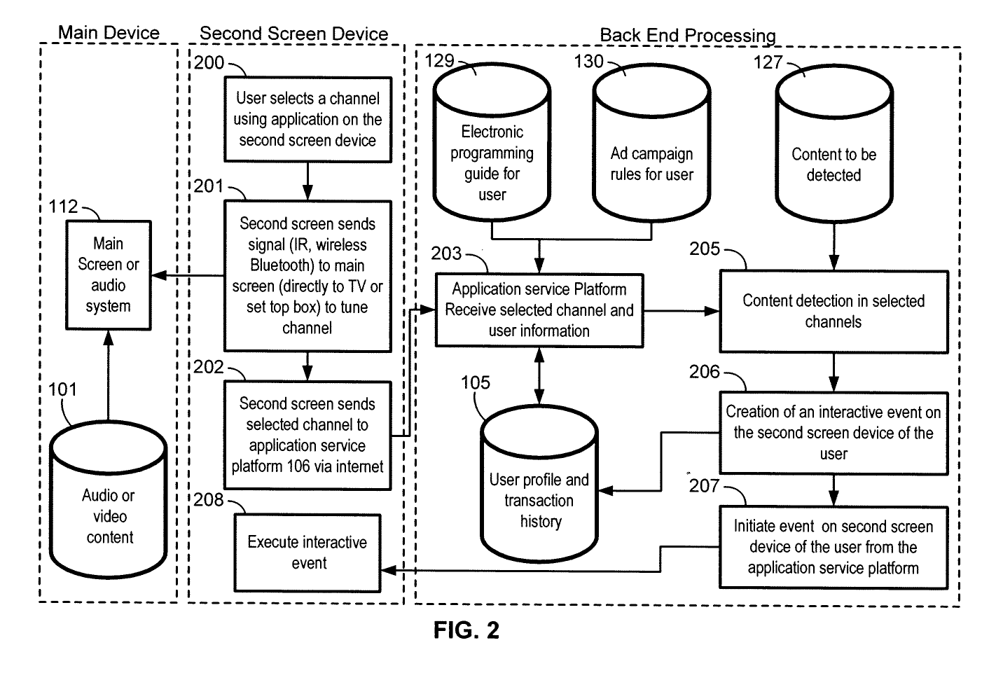

FIG. 2 shows a flow chart of the system. An application installed on the second screen 111 can communicate with the set-top box 121 or the main screen 112. Using this application, the user selects a channel 200 and the application on the second screen sends a signal 113 (e.g. IR, wireless, Bluetooth or any near field communication technology or Wi-Fi) to tune the channel on the main screen 201 or set top boxes 121, OTT boxes 121, connected TVs 112, non connected TVs 112, Blu-ray players, and any other video or audio playing devices. The second screen also sends the channel information to the application service platform 202 in the backend processing system. In the back-end system, the media listener continuously analyzes the audio and video content to extract specific video, closed-captioned text and audio stream. The application service platform 203 uses a copy of the Electronic Programming Guide 129 relevant to the media consumer since this information is in the Users information and Profile and transaction history module 105. The application service platform has the information of what is the channel being watched by the user and what this channel content is for the user because of the EPG (e.g. channel 3 corresponds to CNN). The mapping of these two information pieces allows the system to listen to the channel being watched (or listened to) 205 and match for specific key audio segments, text, and images kept in the database 127 with the live main video program extracted by the media listener. When a match occurs, it triggers interactive events 206. Because the data repository 127 includes sounds, text, and images (video frames), any portion of the program can be detected including advertisement. This enables advertisement campaign managers to program interactive events (e.g. ads, coupons) that are executed on the second screens 111 which are directly targeted to the user based on what he/she is watching.

When the system detects an ad or specific content 205 associated with the user and channel being watched on the main screen, it creates an event 206 to be transmitted to the second screen 207 and specific information about the user and the content is stored for future processing in the user profile database 105. With this system, it is possible at any given time to know what the user is watching or listening to and correlate this information to develop a media consumer profile and historical data to enable interactivity and data mining 105.

Even though sound capture on the second screens is not a necessary condition for matching the program being played with what is watched by the media consumer, a sound capture device (a microphone) 140 can be used to complement and further exploit the system. Sound samples recorded from the main screen speakers can be sent to the audio and image segment detection component 103 to be matched and identified on the same database of key audio segments 127. Every time a tuning event (channel change) takes place in the applications 116, a few seconds of audio recording can be automatically captured by 140 without an explicit recording intervention by the media consumer. The sound samples are sent to block 103 for matching, identification, and confirmation of the channel being watched. This provides a complete feedback mechanism to the tuning function in 116 through blocks 103,106,129. This feedback mechanism can be used to ascertain the information on the tuned channel and its associated main screen program are truly in sync by comparing the match given by the sound capture with the match provided by the back end system. If the information does not match an interactive event can be executed on the second screen to inform the users and engage into a dialog to fix the synchronization issue. Issues such as (but not limited to) bad EPG information provided by the user or the network, an infrared device error, a superfluous remote control (not the one provided by the second screen application) being used can be detected and fixed.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A system for executing on a secondary screen device interactive events linked to predetermined program content played on a main screen device, said secondary screen device having channel tuning capability for selecting channels to be played on said main screen device, said system comprising:
an application service platform adapted to communicate with said secondary screen device for monitoring said channels selected to be displayed on said main screen device and determining when said predetermined program content is played on said main screen device, said application service platform also being adapted to send to said secondary screen device one or more of said interactive events linked to said predetermined program content.

2. The system of claim 1, further comprising an application executed on the second screen device in communication with said application service platform to provide said application service platform with information said selected channels, and to execute said interactive events on said second screen device.

3. The system of claim 1, wherein said second screen device is selected from a group consisting of a tablet, a PC, a laptop and a smartphone.

4. The system of claim 1, wherein said pre-determined program content comprises video and/or audio.

5. The system of claim 1, wherein said channel tuning capability is selected from a group consisting of IR codes, IP commands, WIFI commands, and Bluetooth commands.

6. The system of claim 1, further comprising a management platform to configure the pre-determined program content to be monitored by the application service platform.

7. The system of claim 1, wherein said interactive event comprises a targeted advertisement.

8. The system of claim 1, wherein said interactive event comprises a web application enabling a targeted commerce transaction.

9. The system of claim 1, wherein said interactive event comprises an electronic coupon.

10. The system of claim 1, wherein said interactive event comprises an application to be executed or launched on said second screen.

11. The system of claim 1, further comprising a reporting application coupled with said application service platform to gather data on usage of the system.

12. The system of claim 1 wherein said interactive event comprises a ballot for voting or polling opinions.

13. A method for executing on a secondary screen device interactive events linked to predetermined program content played on a main screen device, said secondary screen device having channel tuning capability for selecting channels to be played on said main screen device, said method comprising:
monitoring said channels selected to be displayed on said main screen device;
determining when said predetermined program content is played on said main screen device; and
sending to said secondary screen device one or more of said interactive events linked to said predetermined program content.

14. The method of claim 13, further comprising providing information on said selected channels and executing said interactive events on said second screen device.

15. The method of claim 13, wherein said second screen device is selected from a group consisting of a tablet, a PC, a laptop, and a smartphone.

16. The method of claim 13, wherein said pre-determined program content comprises video and/or audio.

17. The method of claim 13, wherein said channel tuning capability is selected from a group consisting of IR codes and Bluetooth commands.

18. The method of claim 13, further comprising configuring the pre-determined program content to be monitored.

19. The method of claim 13, wherein said interactive event comprises a targeted advertisement.

20. The method of claim 13, wherein said interactive event comprises a web application enabling a targeted commerce transaction.

21. The method of claim 13, wherein said interactive event comprises an electronic coupon.

22. The method of claim 13, wherein said interactive event comprises collecting polling or voting information.

23. The method of claim 13, wherein said interactive event comprises an application to be executed or launched on said second screen.

24. The method of claim 13, further comprising a reporting application coupled with said application service platform to gather data on usage of the system.
